(19) United States
(12) Patent Application Publication
(10) Pub. No.: US 2008/0247468 A1
(43) Pub. Date: Oct. 9, 2008

(54) METHOD AND SYSTEM FOR PERFORMING RATE CONTROL ADAPTED TO CHANNEL CONDITIONS

(75) Inventor: Carolina Blanch Perez de Notario, Navarra (ES)

Correspondence Address: KNOBBE MARTENS OLSON & BEAR LLP, 2040 MAIN STREET, FOURTEENTH FLOOR, IRVINE, CA, 92614, US

(73) Assignee: Interuniversitair Microelektronica Centrum vzw (IMEC), Leuven (BE)

(21) Appl. No.: 12/098,234

(22) Filed: Apr. 4, 2008

Related U.S. Application Data
(60) Provisional application No. 60/910,422, filed on Apr. 5, 2007.

(51) Int. Cl. H04N 7/24

(52) U.S. Cl. 375/240.26; 375/E07.003

(57) ABSTRACT

A method and system for determining in real time the instantaneous output rate of a low delay video frame encoder/application for encoding a video frame to be transmitted are disclosed. The video frame encoder provides its output for wireless transmission over a telecommunication channel. In one aspect, a method comprises providing an estimate of the instantaneous channel conditions under which the video frame will be transmitted. The method further comprises determining the instantaneous output rate by selecting a high output rate when the channel conditions considered acceptable and selecting a low output rate when the channel conditions are considered unacceptable.

### CROSS REFERENCE TO RELATED APPLICATIONS

This application claims priority under 35 U.S.C. §119(e) to U.S. provisional patent application 60/910,422 filed on Apr. 5, 2007, which application is herein incorporated by reference in its entirety.

### BACKGROUND OF THE INVENTION

1. Field of the Invention

Certain inventive aspects relate to methods (and computation systems implementing the methods) for rate control, used in video coding applications, the methods being suited for use with wireless communication systems.

2. Description of the Related Technology

Video transmission over wireless communication systems, where energy is a limited resource, faces the challenge to achieve the required performance at minimal energy consumption. Moreover, the negative impact of channel errors on the perceptual video quality makes the transmission over error-prone channels even more challenging. To combat the effect of channel losses, error protection and concealment strategies are applied at the codec, as well as the network and lower layers (e.g., Forward Error Correction (FEC), Automatic Repeat Request (ARQ), channel coding etc).

The encoder, steered by the rate control (RC) mechanism, produces a data bit rate which is passed to lower communication layers (e.g. network, link and physical layers). The energy invested at the lower layers to guarantee a successful delivery, is highly dependent on both the channel conditions and on the amount of bits transmitted during varying conditions. The worse the channel conditions are, the higher the energy invested per bit is. Consequently, the more bits are transmitted, the higher the energy consumption is. Reference is made to rate control also in US Patent Publication No. 2002/0114393.

In [“Stochastic channel-adaptive rate control for wireless video transmission”, Journal on PRL (2004) R. Chandramouli, et al.], [“Rate Control for Robust Video Transmission over Burst-Error Wireless Channels”, IEEE Journal on Selected Areas in Communications, May 1999. Chi-Yuan Hsu et al], [“Adaptive Rate Control Scheme for Video Streaming Over Wireless Channels”, Proc of DCC'04. M. Krunz et al.] optimized rate control strategies adapted to models of time varying channels are presented. These studies focus on the impact of delay constraints on the end video quality. In [Chi-Yuan Hsu et al ] the rate constrains are derived from the channel model using complex Rate Distortion optimization techniques, more suited for scenarios with longer end-to-end delay, yielding both PSNR increases and a reduced packet error rate. In [R. Chandramouli, et al.] a learning mechanism adapts the rate to the channel bit error rate. Packet errors are not considered and no impact of the feedback delay or algorithm complexity is given. In [M. Krunz et al] hybrid ARQ/FEC schemes are used together with joint source/channel coding with the receiver signaling to the transmitter the frame size scaling needed to meet the time constraints.

These studies focus on video adaptation to meet delay constraints arising from the channel conditions. The complexity of the algorithms proposed imposes constraints on the video coding and makes them unsuitable for low complexity low delay real time applications. Finally, critical issues such as the impact on the communication energy are not addressed.

### SUMMARY OF CERTAIN INVENTIVE ASPECTS

One inventive aspect provides a cross-layer approach in which the video codec becomes network aware in order to decrease the communication energy. The channel conditions are feedback to the RC mechanism of the encoder that steers the output rate accordingly. Under bad channel conditions, when the communication energy per bit is high, the RC reduces the output rate to save energy. On the contrary, if the channel conditions are good, communication energy is low, and the channel-adaptive RC steers the encoder to a higher instantaneous output rate, while the average target bit rate and video quality are maintained.

One inventive aspect focuses on the energy consumption during video transmission and aims at reducing the communication energy by adapting the codec output rate to the channel conditions. Moreover, the approach can be realized at real-time as it has low complexity incurring in no additional delay. This makes it suitable for low complexity low delay video applications, where energy consumption becomes a critical issue. Indeed low energy consumption is one of the main challenges for wireless video transmission on battery limited devices. The energy invested at the lower layers of the protocol stack involved in data communication, such as link and physical layer, represent an important part of the total energy consumption. This communication energy highly depends on the channel conditions and on the transmission data rate. Traditionally, video coding is unaware of varying channel conditions. One inventive aspect provides cross-layer approach in which the rate control mechanism of the video codec becomes channel-aware and steers the instantaneous output rate according to the channel conditions to reduce the communication energy.

Results show that energy savings up to 30% can be obtained with a reduction of barely 0.1 dB on the average video quality. The impact of feedback delays is shown to be small. In addition, the adaptive mechanism has low complexity, which makes it suitable for real-time applications.

One inventive aspect provides channel adaptive (hence depending on channel conditions) rate control for energy optimization (in particular taking into account communication energy).

The foregoing inventive aspects can fit into methods for operating a combined multimedia-telecom system as described in US Patent Publication No. 2006/0114836 or can be used independently thereof. Further the method can be used with rate controllers as US Patent Publication No. 2002/0114393.

### BRIEF DESCRIPTION OF THE DRAWINGS

FIG. 1 is a diagram showing the Energy per bit—PER curves for channel state (CS) 1 and 5, and different MAC packet sizes (PS).

FIG. 2 is a diagram showing a channel state sequence a sequence according to certain models.

FIG. 3 is a diagram showing the size of the frames produced by the normal rate control and by the channel adaptive rate control.

FIG. 4 is a diagram showing the normalized communication energy per frame for Foreman, normal rate control, and adaptive rate control.

FIG. 5 is a diagram showing the cumulative energy of FIG. 4.

FIG. 6 shows a flowchart of one embodiment of a method of determining in real time the instantaneous output rate of a low delay video frame encoder or an encoding application for encoding a video frame to be transmitted.

FIG. 7 shows a block diagram illustrating one embodiment of an apparatus for determining in real time the instantaneous output rate of a low delay video frame encoder/application for encoding a video frame to be transmitted.

### DETAILED DESCRIPTION OF CERTAIN INVENTIVE EMBODIMENTS

The present invention will be described with respect to particular embodiments and with reference to certain drawings but the invention is not limited thereto but only by the claims. The drawings described are only schematic and are non-limiting.

### Network Modeling

The following subsections present the channel modeling used as well as the model of communication energy involved in video transmission in one exemplary embodiment.

### A. Channel Modeling

A wireless environment is assumed with a feedback channel where an a priori probabilistic model of the channel behavior is available at the encoder. The burst-error wireless channel may be modeled with, for example, an 8-state Markov model [“Optimal fixed and scalable energy management for wireless networks,” INFOCOM'05, USA, R. Mangharam,et al.]. Based on experiments for indoor WLAN a channel coherence time of 120 ms is assumed. This is, the channel remains constant for 3 or 4 video frames of the video sequence (encoded at 25 or 30 frames per second), while the RC mechanism adapts on a frame time basis.

### B. Energy Modeling in the Wireless Network

We may use, for example, the energy models developed in [R. Mangharam,et al.] where expressions for the Packet Error Rate (PER), Energy and Transmission time for each packet are derived taking into account the 802.11e MAC protocol and the above mentioned 8-state Markov channel model. The model assumes a scalable 802.11a physical layer, where it is possible to adapt the modem configuration to the current environment and traffic demands.

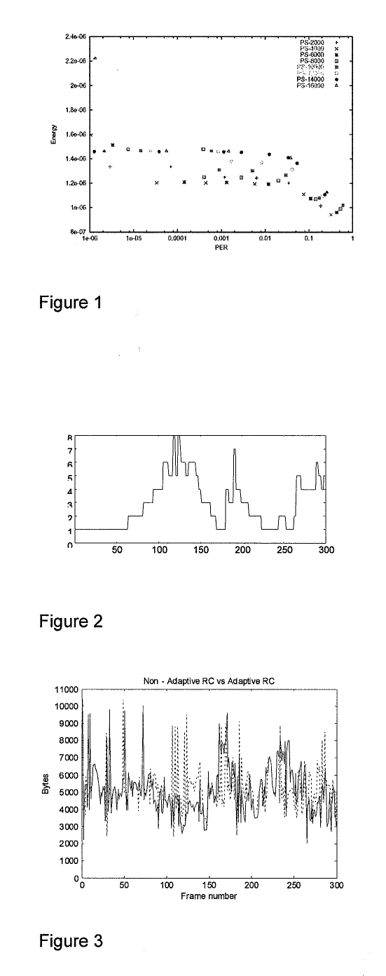

For simplicity of the discussion, we assume only a single user on the considered wireless link, although the invention is not limited to such use. The overhead considered for the energy modeling is hence only the header and retransmissions overhead. No congestion is considered for a single MPEG-4 user over a 54 Mbps WLAN link. We hence focus, for each channel state, on the expected Energy per bit for a certain targeted Packet Error Rate (PER) as function of the 802.11a modem settings. FIG. 1 shows the Energy per bit-PER curves for channel state (CS) 1 and 5, and different MAC packet sizes (PS).

Each point represents a specific configuration of the control settings Ki,j for user i and j control knobs, for a given wireless LAN architecture, such as modulation, code rate, . . . etc

Only the discrete points can be allocated in practical communication links. Configuration points can be determined at the design time (or during a calibration process) of the transceiver. Simulations are carried out using verified energy-performance models on a simulator. We retain for each channel state (CS) a single representative Energy-PER configuration point, to be used for the results in the remainder of this paper. We select for each CS the point with the lowest energy consumption, subject to a very low PER constraint (near to error-free quality), as we want to see how the required energy scales with channel conditions. The global communication energy is extracted from this expected energy per bit per CS as follows:

$$TotalEnergy = {\sum }_{i = 1}^{i = 8} {R}_{i} * {E}_{i} \qquad ( 1 )$$

Rᵢ: amount of bits transmitted during CS i
Eᵢ: expected Energy per bit for CS i.

The operation points taken from the Energy-PER curves are selected from the optimal trade-off curve where the lowest energy is spent for a certain PER and for a very low PER to assume near to error-free quality. The MAC packet size is taken to be 8000 bits for all channel states. Table 1 gives the occurrence probability and Energy per bit in Joules for each CS. CS 1 corresponds to the best channel conditions while CS 8 to the worst ones.

TABLE 1
CS probabilities and associated Energy/bit

| CS | 1 | 2 | 3 | 4 | 5 | 6 | 7 | 8 |
|---|---|---|---|---|---|---|---|---|
| Pr | 18.6 | 33.6 | 25.8 | 13.4 | 4.8 | 1.8 | 0.8 | 1.2 |
| E/bit | 1 | 1.5 | 2.6 | 5 | 15 | 25 | 45 | 45 |

From Table 1 we can see that the required energy per bit dramatically increases when channel conditions get worse. Bad CS (5 to 8) with a low occurrence probability (around 8% all together), can actually be responsible for roughly 50% of the energy consumption at the network side. The actual energy value depends both on the amount of bits coming from the application and on the current CS. This highly motivates the need for a channel aware video coder that produces an amount of bits according to the current channel conditions.

### Rate Control Mechanism

The use of the RC mechanism typically flattens the overall bit rate variation. However, the frame size variations between consecutive frames are still high (factor 2 or 3). As the RC mechanism is network unaware, peaks in the frame sizes can coincide with bad channel conditions in the network. During these bad CS the communication energy invested per transmitted bit increases highly.

If a RC mechanism steers the instantaneous output video rate according to the network conditions, the network effort can be alleviated. Thus, by reducing the amount of bits to be transmitted during bad channel conditions the communication energy is reduced. Similarly, under good channel conditions where the network energy per bit required is much lower, the RC increases the output bit rate to profit from the good network condition.

FIG. 2 shows a sequence of CS according to model discussed before. In FIG. 3 we can see the size of the frames produced by the normal RC (dashed line) and by the Channel Adaptive RC (solid line).

The standard RC mechanism [“A new rate control scheme using quadratic rate-distortion modeling”, IEEE Trans. Circuits Syst. Video Tech., February 1997. T. Chiang and Y. Q. Zhang] allocates bits without considering current channel conditions. This way, big frames may be transmitted during bad CS, when the energy invested per bit needs to be high. On the contrary, the adaptive RC generates bigger frames during good CS and smaller frames during bad CS. The bit rate peaks of the normal RC during bad CS, are then reduced while bigger frame sizes (rate peaks) are generated during the good channel conditions.

The following section deals with one embodiment of the algorithm modifications on the RC mechanism of MPEG-4 to become channel-adaptive.

### A. Channel-Adaptive Rate Control Mechanism

The purpose of the RC mechanism is to determine the number of bits allocated per frame so as to meet an overall target bit rate. In the channel-adaptive RC the bit allocation per frame is done based on the CS under which the frame is sent. Our RC approach follows the same processes as the standard RC:

1) Variable initialization

Based on the overall target bit rate, target frame sizes are estimated for every kind of frame (I, P and B). In our adaptive RC we classify frames according to the channel condition during which they are sent. We estimate the amount of frames under each CS i as:

num_{—}P_Frame_{—}i=num_{—}P_Frame_Total*Pr_{—}i (1)

where Pr_i is the CS probability and num_P_Frame_Total is the number of frames considered during the initialization, in our experiments 300 frames. In practice, the model probabilities could be re-estimated from channel measurements and used to reinitialize these variables every certain number of video frames.

While preserving the overall target bit rate, we compute initial target frame sizes in bits (3) for frames transmitted under different CS as a scaled version of the hypothetical average Frame size (2):

AverFrameSize=Total_bit_rate/frame_rate (2)

AverFrameSize_{—}i=AverFrameSize*Factor_{—}i (3)

The scaling factor is smaller than 1 for bad channels so as to reduce the produced bits during bad conditions and slightly bigger than 1 during good channel conditions. To maintain the overall target bit rate, the scaling factor for the best channel k condition is adjusted based on the rest of scaling factors:

bit_rate_k=Total bit rate−Σ(bit_rate_{—}i), [symbol] (4)

Factor_{—}k=bit_rate_{—}k/(num_Frame_{—}k*AverFrameSize) (5)

The initial target bit rate per group of frames transmitted under CS i is estimated as:

bit_rate_{—}i=num_Frame_{—}i*(AverFrameSize_{—}i) (6)

After this initialization, the current CS is measured and feedback to the encoder, which applies the corresponding initial target frame size for that channel to the current frame.

2) Computation of Quantization Parameter

As in the standard RC and according to the Video Buffer Verifying (VBV) model, the QP of the current frame is computed based on the target frame size, QP and MAD (Mean Absolute Difference) of the previous frame.

3) Rate Distortion Model Update

Once the QP is selected, the frame is encoded and the R-D model is updated prior to the encoding of the next frame. Re-computation of variables is performed as in the standard RC [“A new rate control scheme using quadratic rate-distortion modeling”, IEEE Trans. Circuits Syst. Video Tech., February 1997. T. Chiang and Y. Q. Zhang]. To steer the output bit rate, in addition to QP variation, our approach uses frame skipping, as also allowed in the MPEG-4 coding scheme. During the worst channel conditions (CS 7 and 8) the frame rate is reduced to produce less bits. As this occurs with very low probability (around 2% of the time) the frame rate is only slightly reduced from 30 frames per second (fps) to around 29 fps.

### B. Impact on Video Quality

On one hand, the frame size reduction and frame skipping during bad CS slightly degrades the video quality. Nevertheless this degradation is limited to a small percentage of time (due to 2% probability of bad channel states as 7 or 8). In addition, the scaling factor applied is also used to limit the degradation.

On the other hand, the bit reduction allows saving energy when the transmission is more costly. Moreover, more bandwidth becomes available for error protection or retransmissions, which can reduce the packet error rate (PER) and yield a better end quality. Usually, it is preferable to allow higher coding distortion with no PER than a higher PER.

Frames size reduction during bad channel conditions causes a small quality decrease, while a quality increase during good channel conditions. Frame quality variations stay in any case within the range of variations that occurs with current RC approaches. In the standard RC variations of even 7 dBs can be observed along the sequence, with often variations of 2 or 3 dBs between consecutive frames. The average PSNR decrease corresponding to the adaptive RC is barely 0.2 dB. The impact in terms of motion jerkiness has been visually assessed to be minimal and the average frame rate is very slightly reduced. However the gain in energy is high, as further will be shown that savings of 46% are obtained by allowing this marginal quality degradation.

### C. Choice of Scaling Factors

The scaling factors determine the target frame size reduction or increase for frames in a particular channel condition. The scaling applied determines as well the quality increase or degradation allowed for a particular frame. For our experiments the values in Table 2, showing good energy-quality tradeoff, are empirically obtained.

TABLE 2
Scaling factors applied

| | | | | |
|---|---|---|---|---|
| Channel | 1-2 | 3-4 | 5-6 | 7-8 |
| Factor | >1 | 0.9 | 0.7 | 0.6 |

The lower the scaling factor, the higher the frame quality degradation allowed. Nevertheless, the perceived quality degradation associated is partly dependent on the overall target bit rate. The higher the bit rate, the higher the encoding quality is and the impact of bit rate reduction becomes less noticeable. This way, for Foreman and target bit rates of 2 Mbps or 1 Mbps, no quality degradation is perceived. For lower target bit rates, such as 500 Kbps the quality degradation can become more noticeable for aggressive scaling factors. The scaling factors that provide the best tradeoff in terms of energy and quality can be determined during a profiling phase. On general terms its selection depends on the targeted encoding quality and on the occurrence probability of the CS.

### D. Impact of Non Idealities

1) Mismatch of Channel Probabilities

The channel-adaptive RC is based on a prior knowledge of the CS probabilities. In practice, a slight mismatch occurs between the expected model probabilities and the probabilities observed in a shorter channel realization, which cannot reflect the global channel statistics. We observe that this mismatch does not impair the efficacy of the adaptive RC mechanism. The effect is that channel sequences with a higher probability of bad CS allow higher energy savings while lower bad CS probabilities diminish the potential savings.

2) Impact of Feedback Delay

The efficiency of any channel adaptation highly depends both on the speed at which the conditions are varying and the speed of the adaptation to these variations. The speed at which the channel conditions change is given by the coherence time of the channel, defined as the time, during which the channel remains unchanged. The RC mechanism only adapts at every video frame (33 ms at 30 fps). In certain applications, this requires the coherence time of the channel to be equal or longer to one video frame so that the adaptation can be performed timely.

On the other hand, channel information needs to be accurate and timely received to allow a correct adaptation. In practice, the information is feedback with a certain delay. In channel reciprocity is assumed, the CS can be computed at the transmitter with no incurred delay. If feedback from the receiver, the delay is piggybacked in the ACK and bounded by transmission of DATA (of MTU length)+SIFS+ACK transmitted at 6 Mbps, which is around 3 ms. If feedback arrival is while encoding of the current frame already started, then the CS may be used for the next frame so a feedback delay of one happens. Two or even a few video frames can occur only if more than one link is considered. In next section we asses the impact of the delay on the adaptation efficiency. In current systems channel estimation is foreseen at the physical layer, then a few multiplications and a look-up table for obtaining CS incurs in marginal complexity.

### E. Testbench

We use the MPEG-4 Simple Profile codec [Motion estimation for low power video devices”, Proc of the IEEE ICIP01, Greece, C. De Vleeschouwer and T. Nilsson] and the video sequences Foreman (encoded at 500, 1000 and 2000 Kbps) and Calendar and Mobile (at 2, 4 and 6 Mbps). Tests are run and averaged over several channel sequences.

### Results and Analysis

This section shows the results obtained for particular channel sequences as well as averaged results over different instantiations of channel sequences.

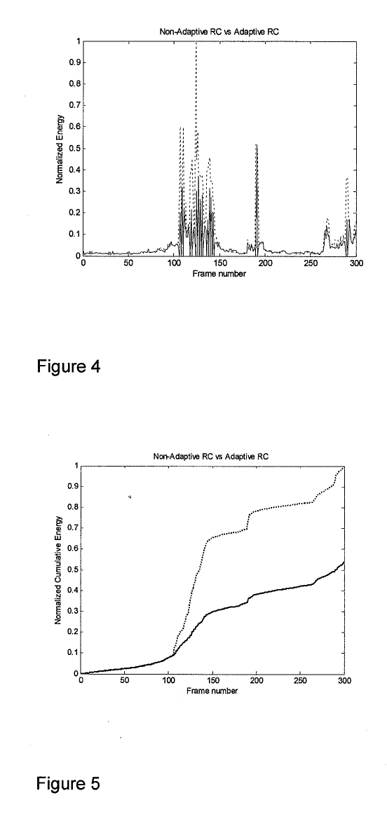

FIG. 4 shows the normalized communication energy per frame (1 corresponds to 0.35 joules) for Foreman, normal RC in dashed, adaptive RC in solid line. It corresponds to the channel sequence in FIG. 2. During bad channel conditions (between frames 100 to 150) the adaptive RC reduces the frame. This reduces the energy spent for transmission by at least factor 2 during bad channel conditions.

FIG. 5 shows the cumulative energy of FIG. 4, normalized to the maximum (8 joules). For this case we can see how 46% of the communication energy can be saved, by using the adaptive RC (solid line). The results averaged over different channel sequences for Foreman at 1 Mbps are presented in the following tables. Averaged results for Mobile and different bit rates yield similar results.

Table 3 shows average energy savings of 14% for Foreman at 1000 Kbps with the adaptive RC without frame skipping. Feedback delays of 1 or 2 video frames (40 or 80 ms delay), can reduce energy savings around 3 or 5%.

The Adaptive RC with frame skipping attains savings of 31% of the communication energy for Foreman and at least 30% for Mobile. Around 1 or 2% of the frames are skipped, without degrading the perceptual visual quality and maintaining the average target bit rate. The effect of feedback delay on the performance is not dramatic (savings reduced between 5 and 8%), as most CS transitions happen between neighbor CS.

TABLE 3
Adaptive RC without frame skipping

| | Normal | Adaptive | | |
|---|---|---|---|---|
| | RC | RC | 1fr delay | 2fr delay |
| Energy (j) | 24.69 | 21.22 | 21.75 | 22.34 |
| % Saving | 0% | 14.07% | 11.07% | 8.91% |
| Av. PSNR | 36.16 | 36.05 | 36.05 | 36.05 |
| Bitrate(kbps) | 1000 | 995 | 995 | 995 |

TABLE 4
Adaptive RC with frame skipping

| | Normal | Adaptive | | |
|---|---|---|---|---|
| | RC | RC | 1fr delay | 2fr delay |
| Energy (j) | 24.69 | 17.02 | 18.26 | 18.53 |
| % Saving | 0% | 31.08% | 25.82% | 24.43% |
| Av. PSNR | 36.16 | 36.05 | 36.05 | 36.05 |
| Framerate | 25 | 24.3 | 24.3 | 24.3 |
| Bitrate(kbps) | 1000 | 968 | 968 | 968 |

In summary a channel-adaptive RC mechanism is proposed that steers the instantaneous encoding rate according to the network conditions. The transmission power is optimized (saving of up to 30%) under quality constraints (barely 0.1 dB degradation). Moreover, the mechanism is of low complexity and suitable for real-time applications.

The adaptive RC not only reduces the communication energy but also allows investing more bits in error protection and correction, which in turn can increase the end video quality.

The approach (demonstrated for a single user) is easily extendible to a multiple user context. Moreover the approach, here demonstrated for 4 Simple Profile codec can easily be extended to an adaptive RC approach in combination with an Advanced Video Codec, where frame size reduction can be performed by increase of the QP and also by applying more complex coding tools. As these tools involve an increase of coding energy the tradeoff with the communication energy can be exploited.

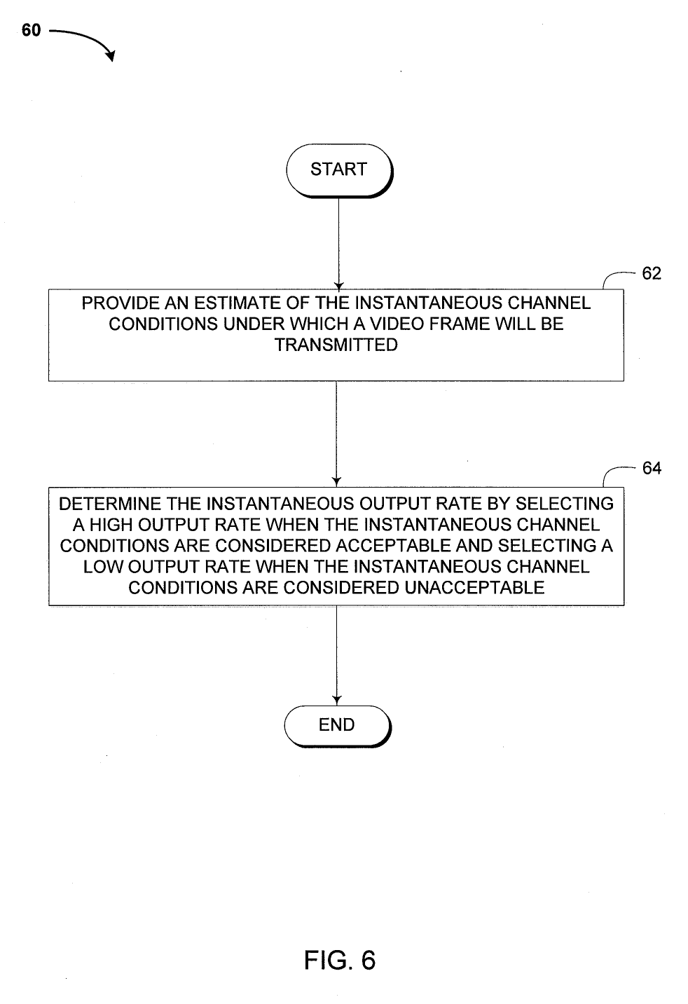

FIG. 6 shows a flowchart of one embodiment of a method of determining in real time the instantaneous output rate of a low delay video frame encoder or an encoding application for encoding a video frame to be transmitted. The video frame encoder provides its output for wireless transmission over a telecommunication channel. The method 60 starts at a block 62, wherein an estimate of the instantaneous channel conditions under which the video frame will be transmitted is provided. Moving to a block 64, the instantaneous output is determined by selecting a high output rate when the instantaneous channel conditions considered acceptable and selecting a low output rate when the instantaneous channel conditions are considered unacceptable.

In one embodiment, the video encoder and wireless transmission scheme are designed for an average target bit rate frame, and the determining of the instantaneous output rate is performed such that the average target bit rate is maintained.

In one embodiment, the selection is performed to minimize the energy needed for the wireless transmission.

In one embodiment, the method 60 further comprises initializing a relationship between the instantaneous output rate and the instantaneous channel condition under which the video frame will be transmitted.

In one embodiment, the initialization of a relationship is performed once and before the providing of an estimate of the instantaneous channel conditions and the determining of the instantaneous output rate based on the relationship.

In one embodiment, the method 60 is performed for a sequence of video frames and wherein the relationship is updated based on channel measurements after the method 60 is performed for a predetermined amount of video frames.

In one embodiment, the instantaneous output rate is used to select the quantization parameter of the video encoder.

In one embodiment, the instantaneous output rate is used to decide whether or not to skip a video frame.

In one embodiment, the initialization is selected to minimize the video quality degradation due to the output rate selection.

In one embodiment, the initialization is based on estimated channel state probabilities.

In one embodiment, the estimated instantaneous channel conditions are instantaneous channel conditions received via a feedback telecommunication channel.

In one embodiment, the instantaneous output rate of the low delay video frame encoder/application is the amount of bits per video frame.

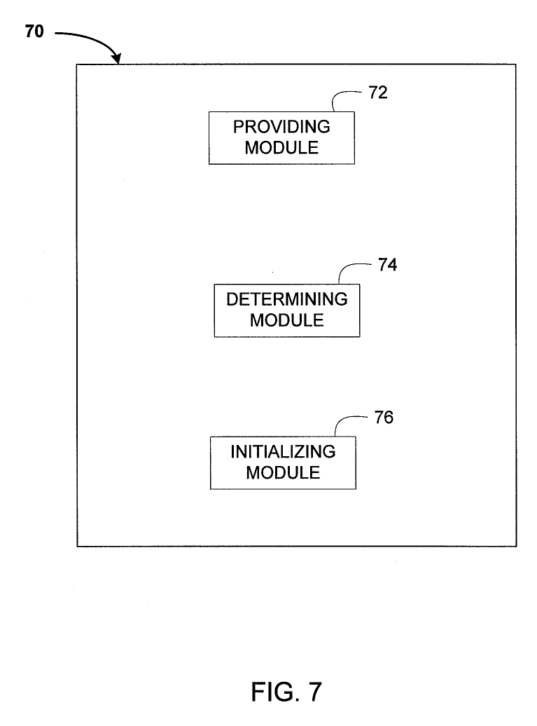

FIG. 7 shows a block diagram illustrating one embodiment of an apparatus for determining in real time the instantaneous output rate of a low delay video frame encoder/application for encoding a video frame to be transmitted. The video frame encoder provides its output for wireless transmission over a telecommunication channel. The apparatus 70 comprises a providing module 72 configured to provide an estimate of the instantaneous channel conditions under which the video frame will be transmitted. The apparatus 70 may further comprise a determining module 74 configured to determine the instantaneous output rate by selecting a high output rate when the instantaneous channel conditions considered acceptable and selecting a low output rate when the instantaneous channel conditions are considered unacceptable.

In one embodiment, the apparatus 70 may be a part of a video encoder.

In one embodiment, the apparatus 70 may optionally comprise an initializing module 76 configured to initialize a relationship between the instantaneous output rate and the instantaneous channel condition under which the video frame will be transmitted.

Although systems and methods as disclosed, is embodied in the form of various discrete functional blocks, the system could equally well be embodied in an arrangement in which the functions of any one or more of those blocks or indeed, all of the functions thereof, are realized, for example, by one or more appropriately programmed processors or devices.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of determining in real time the instantaneous output rate of a low delay video frame encoder/application for encoding a video frame to be transmitted, the video frame encoder providing its output for wireless transmission over a telecommunication channel, the method comprising:
providing an estimate of the instantaneous channel conditions under which the video frame will be transmitted; and
determining the instantaneous output rate by selecting a high output rate when the instantaneous channel conditions are considered acceptable and selecting a low output rate when the instantaneous channel conditions are considered unacceptable.

2. The method of claim 1, wherein the video encoder and wireless transmission scheme are designed for an average target bit rate frame, and the determining of the instantaneous output rate is performed such that the average target bit rate is maintained.

3. The method of claim 1, wherein the selection is performed to minimize the energy needed for the wireless transmission.

4. The method of claim 1, further comprising initializing a relationship between the instantaneous output rate and the instantaneous channel condition under which the video frame will be transmitted.

5. The method of claim 4, wherein the initialization of a relationship is performed once and before the providing of an estimate of the instantaneous channel conditions and the determining of the instantaneous output rate based on the relationship.

6. The method of claim 4, wherein the method is performed for a sequence of video frames and wherein the relationship is updated based on channel measurements after the method is performed for a predetermined amount of video frames.

7. The method of claim 1, wherein the instantaneous output rate is used to select the quantization parameter of the video encoder.

8. The method of claim 1, wherein the instantaneous output rate is used to decide whether or not to skip a video frame.

9. The method of claim 4, wherein the initialization is selected to minimize the video quality degradation due to the output rate selection.

10. The method of claim 4, wherein the initialization is based on estimated channel state probabilities.

11. The method of claim 1, wherein the estimated instantaneous channel conditions are instantaneous channel conditions received via a feedback telecommunication channel.

12. The method of claim 1, wherein the instantaneous output rate of the low delay video frame encoder/application is the amount of bits per video frame.

13. A computer readable storage medium having stored therein a computer program which, when being executed on a computer, performs the method of claim 1.

14. An apparatus for determining in real time the instantaneous output rate of a low delay video frame encoder/application for encoding a video frame to be transmitted, the video frame encoder providing its output for wireless transmission over a telecommunication channel, the apparatus comprising:
means for providing an estimate of the instantaneous channel conditions under which the video frame will be transmitted; and
means for determining the instantaneous output rate by selecting a high output rate when the instantaneous channel conditions are considered acceptable and selecting a low output rate when the instantaneous channel conditions are considered unacceptable.

15. The apparatus of claim 14, wherein the apparatus is a part of a video encoder.

16. The apparatus of claim 14, further comprising means for initializing a relationship between the instantaneous output rate and the instantaneous channel condition under which the video frame will be transmitted

17. An apparatus for determining in real time the instantaneous output rate of a low delay video frame encoder/application for encoding a video frame to be transmitted, the video frame encoder providing its output for wireless transmission over a telecommunication channel, the apparatus comprising:
a providing module configured to provide an estimate of the instantaneous channel conditions under which the video frame will be transmitted; and
a determining module configured to determine the instantaneous output rate by selecting a high output rate when the instantaneous channel conditions are considered acceptable and selecting a low output rate when the instantaneous channel conditions are considered unacceptable.

18. The apparatus of claim 17, wherein the apparatus is a part of a video encoder.

19. The apparatus of claim 17, further comprising an initializing module configured to initialize a relationship between the instantaneous output rate and the instantaneous channel condition under which the video frame will be transmitted.
